(19) United States
(12) Patent Application Publication
(10) Pub. No.: US 2026/0217898 A1
(43) Pub. Date: Jul. 30, 2026

(54) CONTROLLED ADDITION OF LIGAND IN POLYOL SYNTHESIS

(71) Applicant: REPSOL, S.A., Madrid (ES)

(72) Inventors: María Dolores BLANCO GONZÁLEZ, Móstoles, Madrid (ES); Marta DUEÑAS DíEZ, Revere, MA (US); Luisa María FRAGA TRILLO, Móstoles, Madrid (ES); Mónica GARCÍA RUIZ, Móstoles, Madrid (ES); José Antonio CARAZO ANGULO, Móstoles, Madrid (ES); Juan de Dios MIRANDA LÓPEZ-MARIN, Móstoles, Madrid (ES)

(21) Appl. No.: 19/149,110

(22) PCT Filed: Jan. 18, 2024
(86) PCT No.: PCT/EP2024/051182

§ 371 Date: Jul. 18, 2025

(30) Foreign Application Priority Data
Jan. 19, 2023 (EP) 23382041.4

(51) Int. Cl. C08G 18/48; C08G 65/26

(52) U.S. Cl. CPC C08G 18/4825; C08G 18/4829; C08G 65/2606

(57) ABSTRACT

The present invention relates to a process for the alkali metal base-catalyzed preparation of polyols comprising oxyalkylene units, comprising the addition of a ligand for chelating said alkali metal over a total period of time t≥5 min during the reaction time, to a polyol comprising oxyalkylene units, and to the use of said polyol.

### FIELD OF INVENTION

The present invention belongs to the field of polyols of low unsaturation levels, to the synthesis of polyols catalyzed by alkali metals in the presence of an alkali-binding ligand, to the polyols obtainable therefrom and to their uses.

### BACKGROUND OF THE INVENTION

Polyols are alcohols with more than one hydroxyl group, wherein those containing two, three or four hydroxyl groups are commonly known as diols, triols or tetrols, respectively. Polyols may be classified according to their chemistry, such as polyether, polyester, polycarbonate and also acrylic polyols. Polyether polyols constitute one of the main raw materials for manufacturing polyurethanes, materials having a range of applications for creating all kinds of industrial products and consumer basics to make our life more practical, comfortable and environmentally friendly.

Polyether polyols can be synthesized from the anionic polymerization of alkylene oxides, initiated by “starter molecules”, herein identified as synonyms of “initiator molecules”, having active hydrogen atoms such as diols or triols, ethylene glycol, glycerin, ethylene diamine, or sorbitol, and using an alkali hydroxide such as KOH as catalyst. The base-catalysed process is thought to start with the interaction between the basic catalyst and the initiator molecule, which leads to the formation of an anionic species and water. This anionic species is then responsible for a SN2 nucleophilic attack, usually on the less hindered carbon atom of an alkylene oxide monomer, leading to a ring opening and generation of a negatively charged oxygen atom, which becomes available for propagation of the reaction by attacking a second alkylene oxide molecule. The functionality of the final product is thus determined by the functionality of the initiating molecule and the final molecular weight is influenced by the ratio of initiating molecule to alkylene oxide monomer.

In the propagation phase of the reaction, the negatively charged oxygen in the monomer is predominantly a secondary oxygen atom. However, during the base-catalyzed polymerization, a competing rearrangement from an alkylene oxide ether (secondary hydroxyl end groups) to an allyl alcohol with a vinyl termination (primary hydroxyl end groups) generates monofunctional species which also become oxyalkylated, producing a wide range of polyoxyalkylene monols with molecular weights ranging from that of allyl alcohol itself or its low molecular weight oxyalkylated oligomers to polyether monols of very high molecular weight. In addition to broadening the molecular weight distribution of the product, the continuous generation of monols lowers the product functionality. The presence of monols can explain why a finished diol polymer can have a functionality of 1.7, instead of 2.0.

In addition, the presence of the catalyst alkali metals in the medium may slow down the reaction or lead to unwanted unsaturated products, and it is therefore desirable that they are removed from the reaction, or complexed so that they no longer react.

In this regard, cyclic ethers complex potassium ions (European Polymer Journal 1991, 27:891-4).

WO 2007/120243 A2 discloses the synthesis of low molecular weight polyether polyols using a polyethylene as chelating agent. Among the advantages of such ligands are the ready availability, low cost and the fact that polymers and oligomers of ethylene oxide are non-toxic and therefore acceptable for use as food additives.

WO 2007/075480 A2 discloses a molecular weight dependency for a polyoxyethylene-containing additive which acts as a chelating agent in the base-catalyzed alkoxylation of long-chain polyethers. WO 2007/117295 A2 discloses a non-linear, at least trifunctional polyoxyethylene-containing additive as a chelating agent for the base-catalyzed alkoxylation of long-chain polyethers, with no detrimental effect on flexible foams produced therefrom. WO 2007/075482 A1 discloses a polyoxyethylene-containing initiator as a chelating agent in the alkoxylation of long-chain polyethers.

DE 4209358 A1 discloses the use of an amine to reduce secondary reactions.

However, these documents are silent with regards to reducing the unsaturation in polyether synthesis.

In European Polymer Journal 1991, 27:895-9, in Polym. Bull. (2018) 75:1101-1121, or in European Polymer Journal 49 (2013) 3277-3288, the use of a crown ether as ligand for potassium ions is reported and its influence on the weight distribution and level of unsaturations in the produced polyol is also discussed.

The complexing abilities possessed by some non-cyclic polyethers is also known (“Synthesis of Polyether Polyols for Flexible Polyurethane Foams with Complexed Counter-Ion” by Mihail Ionescu, Viorica Zugravu, Ioana Mihalache and Ion Vasile, Cellular Polymers IV, International Conference. 4th. Shrewsbury, UK1 Jun. 5-6, 1997 Paper 8, 1-8.).

EP 0 383 544 A2 discloses a KOH-catalysed polymerization reaction in the presence of a crown ether, which acts as a ligand for the potassium ions. This document discloses that the crown ether is able to reduce the unsaturation of the polyol.

However, a need still exists for an improved base-catalysed synthesis of polyols exhibiting low levels of unsaturation.

### SUMMARY OF INVENTION

The authors of the present invention (the inventors) have surprisingly discovered that when a ligand is added during the base-catalysed synthesis of polyols, said ligand being suitable for chelating the basic catalyst, the resulting polyol has improved properties, such as lower levels of unsaturation. Furthermore, the level of Volatile Organic Compounds (VOCs) may also be reduced, and/or the polyols may be characterized by low polydispersity levels. By noting that the resulting polyols have lower levels of unsaturation, the inventors have realized that the present invention has the further advantage that the duration of the synthesis may be shortened by increasing the rate of addition of the reagents.

Thus, in a first aspect, the present invention is directed at a process for the alkali metal base-catalyzed preparation of polyols comprising oxyalkylene units, comprising the addition of a ligand for chelating said alkali metal over a total period of time t≥5 min during the reaction time, wherein a portion of said ligand is added at a moment in time corresponding to 5 to 100% of the reaction time.

In a second aspect, the present invention is directed at a polyol obtainable according to the process of the invention.

Polyols are starting materials for the synthesis of polyurethanes. Thus a further aspect of the invention relates to the use of a polyol according to the invention, that is, a polyol according to the third aspect, in the synthesis of polyurethanes.

### DETAILED DESCRIPTION OF INVENTION

The gist of the present invention, which is related to the alkali metal base-catalyzed preparation of polyols, lies in the surprising discovery that, instead of adding a ligand for chelating said alkali metal at a single moment in time (such as at the beginning of the reaction or even at the same time as the initiator is added), if the ligand is added in a prolonged manner (pulses or continuously), the resulting polyol has improved properties. In an aspect, the present invention is directed at a process for the alkali metal base-catalyzed preparation of polyols comprising oxyalkylene units, comprising the addition of a ligand for chelating said alkali metal over a total period of time t≥5 min during the reaction time, wherein a portion of said ligand is added at a moment in time corresponding to 5 to 100% of the reaction time. The term “min” is to be understood as minutes.

In the present invention the ligand is added over a total period of time t which is equal to or higher than 5 min, i.e., t≥5 min. In a particular embodiment, t≥8 min, t≥10 min, t≥15 min, t≥20 min, t≥25 min, t≥30 min, t≥35 min or t≥40 min. Preferably, t≥10 min or t≥20 min.

In another particular embodiment, compatible with the latter embodiments, t≤1000 min, t≤800 min, t≤600 min, t≤550 min, t≤500 min, t≤450 min, t≤400 min, t≤350 min, t≤300 min, t≤250 min, t≤200 min or t≤150 min. Preferably, t≤800 min, t≤600 min or t≤300 min. In a preferred embodiment, 5 min≤t≤600 min, 10 min≤t≤600 min, more preferably 20 min≤t≤600 min.

During this total period of time t, the ligand can be added in a continuous manner, in a plurality of pulses, or as any combination of these two alternatives. In the context of the present disclosure, a “pulse” is to be understood as referring to the discrete addition, step-wise or not, of a portion of the total amount of a reagent, preferably the ligand, at a given moment of the reaction. In a preferred embodiment, a pulse is to be understood as the continuous addition of a ligand during at least 1 second, at least 5 seconds, at least 30 seconds, preferably at least 1 minute, more preferably at least 2 minutes. In another preferred embodiment, a pulse is to be understood as the continuous addition of a ligand during no more than 20 minutes, preferably no more than 10 minutes, even more preferably no more than 5 minutes. Preferably, the ligand is added in pulses over said total period of time, preferably in pulses of continuous addition comprised between 1 second and 20 minutes. In a preferred embodiment, a duration of ligand addition that is greater than 20 minutes should be understood as a “continuous addition of ligand” as opposed to a “pulsed addition of ligand”.

In another preferred embodiment, compatible with the former, a pulse is to be understood as the addition of a ligand interrupted by intervals where no ligand is added. In a preferred embodiment, said interval lasts at least 1 second, at least 5 seconds, at least 30 seconds, preferably at least 1 minute, more preferably at least 2 minutes. In another preferred embodiment, said interval lasts no more than 40 minutes, preferably no more than 30 minutes, even more preferably no more than 20 minutes. In a preferred embodiment, when said interval where no ligand is added is shorter than 1 second should be understood as a “continuous addition of ligand” as opposed to a “pulsed addition of ligand”.

In a preferred embodiment, the ligand is added in pulses over said total period of time in pulses of continuous addition comprised between 1 second and 20 minutes, and with intervals where no ligand is added comprised between 1 second and 40 minutes. Most preferably, the ligand is added in pulses over said total period of time in pulses of continuous addition comprised between 5 seconds and 20 minutes, and with intervals where no ligand is added comprised between 5 seconds and 40 minutes.

The skilled person will readily understand the alternatives comprised in each of the above-mentioned three ways of adding the ligand. For example, when added in continuous manner, the ligand can be added at a constant rate, at a varying rate, or as a combination of these two alternatives. When added in a plurality of pulses, the ligand can be added as a set of regular pulses, a non-limiting example being a plurality of pulses wherein the addition of ligand is kept at a constant (or varying) rate for 3 min, with intervals of 7 min where no ligand is added. Also for example, when the ligand is added in a plurality of pulses, the ligand can also be added as an irregular set of pulses, such as a given number of pulses wherein each pulse of constant (or varying) addition rate lasts longer than the previous one.

Any combinations of these are also part of the invention, such as a period of time wherein the ligand is being added at a constant rate, followed by no addition, followed by the addition at a varying rate, followed by a period of addition at a constant rate with pulses of increased rate, and any combinations of these.

The prior art teaches adding a ligand at a single moment in time, specifically at the beginning (or start) of the polymerization reaction. Conversely, the inventors have surprisingly found that when the ligand is added at a later time in the reaction and in a prolonged manner such that the total period of time of addition is equal to or greater than 5 minutes, preferably metered during the reaction in pulsed manner, the polyol product has a surprisingly lower level of unsaturations.

In a particular embodiment, the ligand is metered into the reaction at the same time as the alkylene oxide. In this context, the ligand can either be metered separately, or as a mixture of ligand and alkylene oxide.

Therefore, in the present invention, the total amount of the ligand is not added at the beginning of the reaction.

In a particular embodiment, at least a portion of the ligand is added at a moment in time corresponding to 5 to 100% of the reaction time, preferably all of the ligand is added at a moment in time corresponding to 5 to 100% of the reaction time.

The term “reaction time” or “duration” is to be understood as the period of time starting from the moment the reagents necessary for starting the polymerization are added, for example, when the alkylene oxide is added to the mixture of the initiator and the basic catalyst, until the moment when such reagents and the ligand, are no longer added. Preferably, the reaction time is to be understood as the period of time that starts when the first amount of alkylene oxide is added, and ends when the last amount of alkylene oxide and/or ligand is added.

In the context of the present disclosure, the polymerization reaction is considered to start when the alkylene oxide is put in contact with an active hydrogen-containing initiator molecule and an alkali metal base catalyst. Preferably, the base catalyst is first reacted with the initiator and the resulting alkoxide is dehydrated to remove the water, and only then is the alkylene oxide added. Water removal promotes formation of the anionic form of the initiator (alcoholate, also known as alkoxide) and avoids unwanted reactions such as water acting as initiator as well.

In the context of the present invention, and according to the field of the invention, the “reaction time” period is considered to end when no more alkylene oxide, or no more ligand, is added to the reaction medium, preferably when no more alkylene oxide is added. In addition, in a typical synthesis of a polyol there is a pressure buildup from the start of the reaction until a certain moment in time. The moment in time when the reactants stop being added, preferably when no more alkylene oxide is added, corresponds to the end of such “reaction time” (thus establishing the upper limit of the “reaction time”).

In this way, the person of ordinary skill in the art, customary with the field of polyol synthesis, will readily understand that there is a “reaction time”, which lasts while the reagents are being added, and a “post-reaction time”, which starts when no further reagents are added in the synthesis of the polyol. Usually, the end of such post-reaction occurs when no further pressure drop can be detected in the reaction tank, although this period can be shortened or the post-reaction can be interrupted, if necessary.

In a preferred embodiment, at least a portion of the ligand is added at a moment in time corresponding to 5 to 98% of the reaction time, at a moment in time corresponding to 10 to 98% of the reaction time, at a moment in time corresponding to 10 to 95% of the reaction time, at a moment in time corresponding to 10 to 90% of the reaction time, at a moment in time corresponding to 10 to 80% of the reaction time, at a moment in time corresponding to 15 to 70% of the reaction time or at a moment in time corresponding to 20 to 70% of the reaction time. In a most preferred embodiment compatible with the above, the ligand is added in portions of the total amount. Most preferably, the entirety of the ligand is added in portions of the total amount, such that each portion of the ligand is added at a moment in time corresponding to 5 to 100%, 5 to 98%, 5 to 95%, 5 to 90%, 10 to 90%, 10 to 80%, 15 to 70% or 20 to 70% of the reaction time.

In a particularly preferred embodiment, the entirety of the ligand is added in portions of the total amount, such that at least a portion of the ligand is added at a moment in time corresponding to 5 to 20%, at least a portion of the ligand is added at a moment in time corresponding to 21 to 40%, at least a portion of the ligand is added at a moment in time corresponding to 41 to 60%, at least a portion of the ligand is added at a moment in time corresponding to 61 to 80%, and at least a portion of the ligand is added at a moment in time corresponding to 81 to 100%, of the reaction time.

The skilled person will readily understand that when the ligand is added in pulsed manner, the total number of pulses will depend on the reaction conditions, such as the amounts or the type of polyol to be produced. In a particular embodiment, a portion of ligand is to be understood as an amount corresponding to the total amount of ligand divided by at least the number 3, 4, 5, 6, 10, 15, 20, 30 or 40.

In the present invention, adding at least a portion of the ligand at a moment in time corresponding to 5 to 100% of the reaction time, preferably from 5 to 98% of the reaction time, is to be understood as adding at least a portion of the ligand (continuously or pulsed) at a moment in time comprised between the moment when the first 5% of the reaction time have already passed since the start of the reaction, and the moment when 100%, preferably 98%, of the reaction time has already passed since the start of the reaction. For example, if the reaction time is 500 min, then a moment in time corresponding to 5 to 100%, preferably 98%, of the reaction time is the time frame comprised between 25 min and 500 min, preferably between 25 min and 490 min (t=0 being the moment when the first amount of alkylene oxide is added). In other words, if the reaction lasts 500 min, at least a portion of ligand is added over a period of time t≥5 min between the 25 and 500 min, preferably between 25 and 490 min, of the reaction time.

In a particular embodiment, the ligand is added not before 5 min since the start of the reaction.

In a particular embodiment, at least a portion of the ligand is added not before 5 min since the start of the reaction. Preferably, at least a portion of the ligand is added not before 10 min, not before 20 min, more preferably not before 30 min, most preferably not before 60 min since the start of the reaction.

In another particular embodiment, the ligand is added not after 1000 min since the start of the reaction. Preferably, not after 800 min, not after 600 min, not after 500 min, more preferably not after 450 min, most preferably not after 400 min since the start of the reaction.

Preferably, the ligand is added not before 5 min and not after 1000 min since the start of the reaction. More preferably, the ligand is added not before 20 min and not after 400 min since the start of the reaction.

The above described embodiments are also compatible with a portion of the ligand being added, instead of at least a portion of the ligand being added.

In a particular embodiment, the process of the invention is a process for the alkali metal base-catalyzed preparation of polyols comprising oxyalkylene units, comprising the addition of a ligand for chelating said alkali metal over a total period of time t≥5 min during the reaction time, wherein a portion of said ligand is added at a moment in time corresponding to 5 to 100% of the reaction time, comprising the steps of:
a) contacting a fraction of the total amount of an alkylene oxide compound with an alkoxide, said alkoxide resulting from reacting an active hydrogen-containing initiator molecule and said alkali metal base catalyst;
b) adding to the reaction mixture resulting from step (a),
   i. a fraction of the total amount of said ligand; and/or
   ii. a fraction of the total amount of said alkylene oxide compound; and
c) repeating step (b) a plurality of times until the total amount of said alkylene oxide compound is added.

In a particular embodiment, said alkoxide resulting from reacting an active hydrogen-containing initiator molecule and an alkali metal base catalyst is first submitted to a dehydration step.

Therefore, the process of the invention includes the possibility that the alkylene oxide compound is added throughout the reaction, i.e., from step (a) to step (c), either in a continuous manner, in a plurality of pulses, or as any combination of these two alternatives as described above for the ligand. Preferably, the alkylene oxide is added in a continuous manner, even more preferably at a constant rate.

The process of the invention also includes the possibility that both the alkylene oxide compound and ligand compound are added throughout the reaction, according to any of the embodiments explained above.

In a particular embodiment, the reaction mixture of step (a) also comprises a fraction of the total amount of the ligand compound.

Thus, in a particular embodiment, the first fraction of the total amount of ligand may be added before, or simultaneously, as the first fraction of the total amount of alkylene oxide compound.

Step (c) of the process of the invention requires that any of the steps of step (b) are repeated a plurality of times. In the context of the invention, a plurality of times is to be understood as at least 2 times, at least 3 times, at least 4 times, at least 5 times, preferably at least 6 times, more preferably at least 10 times and even more preferably at least 15 times.

In a particular embodiment, step (a) comprises two steps:
(a1) providing a reaction mixture comprising an active hydrogen-containing initiator molecule and an alkali metal base catalyst, and submitting the product to a dehydration step to remove water; and
(a2) contacting a fraction of the total amount of an alkylene oxide compound with the alkoxide obtained in step (a1).

The person of ordinary skill will know how to put the process of the invention in practice, as the synthesis of polyols has been known for several years. A non-limiting manner of putting the process of the invention into practice is described in the Example section. Advantageously, the process can be conducted autonomously, or semi-autonomously, for example by following the teachings of WO2014108485, which discloses a chemically-operated Turing machine.

Therefore, in a particular embodiment, the process of the invention comprises the use of a chemical Turing machine.

The process of the invention leads to polyol products with a lower level of unsaturations when compared to polyol products obtained by a similar process except that no ligand is added over a total period of time t≥5 min during the reaction time, wherein a portion of said ligand is added at a moment in time corresponding to 5 to 100% of the reaction time. Furthermore, the process of the invention leads to a reduction in the maximum operating pressure. This means that as long as the product specifications are met (for example, unsaturation level below specification), the process of the invention allows an increase in the production capacity, for example, by increasing addition rate of the alkylene oxide and thus reducing the reaction time.

### Initiator

The process for the preparation of the polyols of this invention requires contacting a fraction of the total amount of an alkylene oxide compound with an alkoxide, said alkoxide resulting from reacting an active hydrogen-containing initiator molecule and an alkali metal base catalyst.

In the present disclosure, the term “starter” is synonym to “initiator”, when used in the context of the active hydrogen-containing molecule.

The active hydrogen-containing initiator may be any of the compounds known in the art to be suitable for the preparation of conventional polyols by base catalysis, preferably polyether polyols.

The type of initiator used is not critical, although the average functionality of the polyol product will be largely determined by the functionality of the initiator employed (number of hydroxyl groups). For example, dipropylene glycol has two hydroxyl groups, glycerin has three. Polyols for rigid applications use raw materials containing higher number of hydroxyl groups (functional groups). Sucrose shows a functionality of eight, sorbitol has a functionality of six. Sucrose results in highly branched polyols suitable for rigid foams, whereas alcohols with a lower functionality such as propylene glycol are preferable for flexible materials.

Suitable initiator compounds include but are not limited to water, C₂-C₃₀ diols, C₃-C₃₀ triols, ethylene diamine, mixture of isomers of toluene diamine, polyols containing at least four hydroxyl groups, sugar alcohols, monosaccharides, disaccharide and oligosaccharides.

Examples of C₂-C₃₀ diols are 1,2-pentanediol, ethylene glycol, diethylene glycol, triethylene glycol, propylene glycol, dipropylene glycol, tripropylene glycol, neopentyl glycol, 1,3-propanediol, 1,4-butanediol, pinacol, 1,2-butanediol, 1,3-butanediol, 2,3-butanediol, 1,6-hexanediol, 3-methylpentane-1,5-diol, dodecane-1,12-diol, 1,4-cyclohexanediol, cyclohexanedimethanol, hydroquinone, resorcinol, catechol, bisphenol F or bisphenol A.

Examples of C₃-C₃₀ triols are glycerin, trimethylolpropane, trimethylolethane or 1,3,5-trihydroxybenzene.

In the context of the present invention, an example of polyol containing at least four hydroxyl groups is pentaerythritol, but it can also encompass sugar alcohols, monosaccharides, disaccharide and oligosaccharides. Therefore, in the present invention, suitable initiator compounds include polyols containing at least 4 hydroxyl groups selected from the group consisting of pentaerythritol, xylitol, arabitol, ribitol, α-methylglucoside, sorbitol, mannitol, galactitol, fucitol, iditol, inositol, erythritol or threitol, volemitol, isomalt, maltitol, lactitol, maltotriitol, maltotetraitol, polyglycitol, glucose, fructose, ribose, galactose, xylose, sucrose, lactose, maltose, trehalose, cellobiose and chitobiose.

In a preferred embodiment, the initiator compound is selected from the group consisting of C₂-C₃₀ diols, C₃-C₃₀ triols, polyols containing at least four hydroxyl groups, sugar alcohols, monosaccharides, disaccharide and oligosaccharides.

In a more preferred embodiment, the initiator compound is selected from the group consisting of 1,2-pentanediol, ethylene glycol, diethylene glycol, triethylene glycol, propylene glycol, dipropylene glycol, tripropylene glycol, polypropylene glycol, neopentyl glycol, 1,3-propanediol, 1,4-butanediol, pinacol, 1,2-butanediol, 1,3-butanediol, 2,3-butanediol, 1,6-hexanediol, 3-methylpentane-1,5-diol, dodecane-1,12-diol, 1,4-cyclohexanediol, cyclohexanedimethanol, hydroquinone, resorcinol, catechol, bisphenol F, bisphenol A, glycerin, trimethylolpropane, trimethylolethane, 1,3,5-trihydroxybenzene, pentaerythritol, xylitol, arabitol, ribitol, α-methylglucoside, sorbitol, mannitol, galactitol, fucitol, iditol, inositol, erythritol or threitol, volemitol, isomalt, maltitol, lactitol, maltotriitol, maltotetraitol, polyglycitol, glucose, fructose, ribose, galactose, xylose, sucrose, lactose, maltose, trehalose, cellobiose and chitobiose.

More preferably the initiator compound is selected from the group consisting of polypropylene glycol, dipropylene glycol, glycerin-based triols, glycerin, sorbitol, and mixtures thereof. Even more preferably, the initiator compound is selected from the group consisting of polypropylene glycol of molecular weight equal to or lower than 400 g/mol, dipropylene glycol, glycerin-based triols of molecular weight equal to or lower than 1200 g/mol, glycerin, sorbitol, and mixtures of glycerin and sorbitol.

The initiator should, however, be capable of forming a salt with an alkali metal base catalyst. The number average molecular weight of the polyol will depend on the relative amounts of alkylene oxide and initiator in accordance with the following equation:

$$Mn = \frac{( wt . initiator + wt . alkylene oxide )}{moles initiator}$$

### Alkali Metal Base Catalyst

The process for the preparation of the polyols of this invention requires contacting a fraction of the total amount of an alkylene oxide compound with an alkoxide, said alkoxide resulting from reacting an active hydrogen-containing initiator molecule and an alkali metal base catalyst. The alkali metal is also not critical as long as it effectively catalyzes the polymerization of alkylene oxides. The alkali metal derives from any suitable source, including alkali metal hydrides, alkali metal carboxylates (for example those of monofunctional carboxylic acids), alkali metal hydroxides, alkali metal alkoxides and phenoxides, and the like. The alkali metal itself (for example, a sodium metal dispersion) may also be used.

In a particular embodiment, the alkali metal is selected from potassium and sodium.

In another particular embodiment, at least a portion of the alkali metal is selected from an alkali metal hydride such as LiH, NaH, KH, RbH, CsH, preferably NaH, KH and CsH.

In another particular embodiment, at least a portion of the alkali metal is selected from an alkali metal carboxylate, such as those of formula R′COOM, with M being an alkali metal as disclosed above and R′ being selected from a linear or branched, optionally substituted, C₁-C₆ alkyl group, preferably a linear or branched C₁-C₆ alkyl group optionally substituted with at least F or Cl.

In another particular embodiment, at least a portion of the alkali metal is selected from an alkali metal alkoxide or phenoxide, such as those of formula R″OM, with M being an alkali metal as disclosed above and R″ being selected from the group consisting of linear or branched C₁-C₆ alkyl group and C₆-C₁₂ allyl group, the alkyl and allyl groups being optionally substituted with linear or branched C₁-C₆ alkyl, C₆-C₁₂ allyl, or halogen.

In a preferred embodiment, the base catalyst is an alkali metal hydroxide, selected from potassium hydroxide, sodium hydroxide, barium hydroxide and cesium hydroxide, or an alkali metal alkoxylate of mono- or polyfunctional alcohols. Preferably it is an alkali metal hydroxide, more preferably potassium hydroxide or sodium hydroxide.

In a preferred embodiment, an alkali metal is combined with the initiator prior to polymerization and reacted to form an alkoxide (synonym to alcoholate), which is the alkali metal salt of the initiator. It may be desirable to remove the water formed at this stage; suitable methods include azeotropic distillation and vacuum stripping.

The amount of alkali metal used can be varied as desired, with the rate of polymerization being generally dependent on the alkali metal concentration. The basic catalysts are generally used in amounts ranging from 0.1 to 0.4%, preferably from 0.2 to 0.3%, based on the weight of the resulting polyol.

### Alkylene Oxide

The alkylene oxides useful in the present invention are not critical. They include, but are not limited to, ethylene oxide (EO), propylene oxide (PO), oxetane, 1,2- and 2,3-butylene oxide, isobutylene oxide, epichlorohydrin, 1-pentene oxide, 2,3-pentene oxide, 2-methyl-1,2-butene oxide, 3-methyl-1,2-butene oxide, 1-hexene oxide, 2,3-hexene oxide, 3,4-hexene oxide, 2-methyl-1,2-pentene oxide, 4-methyl-1,2-pentene oxide, 2-ethyl-1,2-butene oxide, 1-heptene oxide, 1-octene oxide, 1-nonene oxide, 1-decene oxide, 1-undecene oxide, 1-dodecene oxide, 4-methyl-1,2-pentene oxide, butadiene monoxide, isoprene monoxide, cyclopentene oxide, cyclohexene oxide, cycloheptene oxide, cyclooctene oxide, styrene oxide, methylstyrene oxide and pinene oxide.

Furthermore, in addition to the alkylene oxides, it is also possible to use other co-monomers which can be metered in individually or in a mixture with the alkylene oxides. The various alkylene oxides and any other comonomers can be metered in a mixture or in blocks. Ethylene oxide can be metered in, for example, in a mixture with the other alkylene oxides or in blocks as a starting, middle or end block. Changes in the block composition can be undertaken during the epoxide metering phase discontinuously or else continuously, within short metering periods.

In a particular embodiment compatible with any of those herein described, the alkylene oxide is selected from ethylene oxide, propylene oxide, oxetane, 1,2- and 2,3-butylene oxide, isobutylene oxide, or mixtures thereof. Preferably, it is selected from ethylene oxide, propylene oxide or mixtures thereof, more preferably it is propylene oxide or propylene oxide and ethylene oxide.

The skilled person is familiar with the fact that the alkylene oxide can be supplied to the reactor in different ways, for example as taught in US2016369051 A1: metered addition into the gas phase or directly into the liquid phase, for example by means of an immersed tube or a distributor ring close to the reactor base in a zone with good mixing. The continuous metered addition of the alkylene oxide is effected such that the safety-related pressure limits are not exceeded, this is important as reported in the examples below. The pressure limits depend on the apparatus being used, which usually fall within a pressure range from 1 mbar to 10 bar, more preferably from 1 mbar to 4 bar. It should advantageously be ensured that a sufficient partial inert gas pressure is maintained within the reactor at least during the startup and metering phase (i.e., during the “reaction time” in the context of this invention). This can be established, for example, by means of noble gases or nitrogen, as reported below in the examples.

The alkylene oxide may be added pulse-wise or continuously, preferably it is added continuously, i.e., without interruptions.

The skilled person will readily understand that the rate of addition will depend on the reaction conditions, such as the reactor volume and the amounts being used. In a preferred embodiment, it is added continuously at a rate from 0.5 to 3 g/min, preferably from 0.5 to 2.5 g/min, more preferably from 1 to 2.5 g/min, even more preferably at a rate from 1 to 2 g/min. The rate of addition of the alkylene oxide may be constant or may vary during the reaction. In a preferred embodiment, the rate of addition of alkylene oxide is constant. The former embodiments are preferably related to a reactor size of 1 L and 500 g of mass. This means that the skilled person will understand how to extrapolate the rate of addition to other reactor volumes and/or reaction masses.

### Ligand

The term “ligand” is synonym to any of “chelating agent”, “chelant”, “chelator”, or “sequestering agent”, and is used herein to refer to a molecule which is suitable for, or capable of, undergoing chelation bonding with an ion, preferably an alkali ion. The ligand of the present invention is therefore a molecule which will form a bond with an ion, preferably an alkali ion. The ligand is thus added to chelate at least one of the cations of the basic catalyst during the alkoxylation process.

The ligand is used to bind the alkali metal and serves to greatly increase the rate of polymerization. As shown in the Examples section, without the ligand, unacceptably high levels of unsaturation, reflecting a high proportion of monol, are produced in a polyether polyol product.

Any ligand capable of complexing with alkali metals is suitable for the purpose of this invention. Non limiting examples of ligands include aprotic dipolar solvents, crown ethers, cryptates, polyamines, glymes, polyethyleneglycols, alcohol ethoxylates, diols, polyols, sulfoxides, aminoxides, phosphineoxides and phase transfer agents.

Non limiting examples of aprotic dipolar solvents include dimethylformamide (DMF), dimethylacetamide (DMA), N-methyl pyrolidone (NMP), hexamethylphosphortriamide (HMPA), dimethylsulphoxide (DMSO) and sulpholane.

Suitable crown ethers include any of the macrocyclic heteroatom-containing ligands known to complex with alkali metals. In general, such crown ethers are monocyclic compounds, but bicyclic compounds having nitrogen bridgehead atoms and having in the hydrocarbon bridging chains at least two additional heteroatoms selected from the group consisting of oxygen, sulfur, and tertiary amino are also suitable for use as the crown ether in the process of this invention. Such bicyclic compounds are sometimes referred to as “cryptates”. Specific examples of suitable and readily available crown ethers and crypates include 12-crown-4, 15-crown-5, 18-crown-6, 21-crown-7, dibenzo-18-crown-6, 2.2.2-cryptate, and dicyclohexano-18-crown-6, where 15-crown-5, 18-crown-6 and dibenzo-18-crown-6 are preferred, even more preferably 18-crown-6. Mixtures of crown ethers may also be used.

Non limiting examples of glymes are dimethyl ethers of ethyleneglycol (monoglyme), diethyleneglycol (diglyme) or polyethylene glycol (polyglymes) and have a general formula CH₃O—(CH₂CH₂O)ₙ—CH₂CH₂OCH₃, with n being an integer from 1 to 20, preferably from 1 to 6.

Polyethylene glycols are structurally related to glymes, and include TPEG and PEG. The polyethylene glycols preferably have a molecular weight of from 150 to 8000, preferably 200 to 7000, more preferably 300 to 7000, more preferably 400 to 7000, more preferably 500 to 7000, even more preferably from 500 to 6000. In a particularly preferred embodiment, the polyethylene glycols have a molecular weight of from 750 to 6000, preferably from 750 to 1750.

Alcohol ethoxylates include, for example, octyl phenol ethoxylate, polysorbate 80 and poloxamers.

Polyols include polyol F3231, which is a triol of molecular weight 5250 obtained from glycerin, and characterized by a functionality of 3, with 72% ethylene oxide. The polyol preferably has a hydroxy functionality of 2-8 more preferably from 2 to 6 and most preferably from 2 to 3. Alternatively, the hydroxy functionality of the polyol compound may be capped with alkyl, preferably methyl, groups as is known to those skilled in the art. The functionality of the polyol may be in an amount ranging between any combination of these values, inclusive of the recited values.

Polyamines include 1,10-phenanthroline, tetramethylethylenediamine, pentamethyl diethylenetriamine, hexamethyl triethylenetetramine, heptamethyl tetraethylenepentamine.

In a preferred embodiment, the ligand is a crown ether, polyol, or PEG. Preferably it is selected from the group consisting of 15-crown-5, 18-crown-6 and dibenzo-18-crown-6, polyol F3231, and a PEG ranging from PEG1000 to PEG1500.

The molar ratio of ligand to alkali metal base catalyst can vary from 1:50 to 5:1, with the range of 1:30 to 1:2 being preferred, more preferably from 1:20 to 1:2, more preferably from 1:15 to 1:2, more preferably from 1:15 to 1:3, even more preferably from 1:10 to 1:4.

If a crown ether is used as ligand, either alone or in combination with any other ligand, the molar ratio of crown ether to alkali metal base catalyst can vary from 1:50 to 5:1, with the range of 1:30 to 1:5 being preferred, more preferably from 1:25 to 1:5, more preferably from 1:20 to 1:5, more preferably from 1:15 to 1:7, even more preferably from 1:11 to 1:9, preferably 1:10. In a preferred embodiment, the only ligand is a crown ether.

If a polyol or a polyethyleneglycol is used as ligand, either alone or in combination with any other ligand, the molar ratio of ligand to alkali metal base catalyst can vary from 1:50 to 5:1, with the range of 1:20 to 1:1 being preferred, more preferably from 1:10 to 1:1, more preferably from 1:10 to 1:2, more preferably from 1:8 to 1:2, even more preferably from 1:6 to 1:2, preferably 1:4.

### Temperature and Duration

Typically, the polymerization of the alkylene oxide(s) is carried out at a temperature of from 30 to 170° C., preferably at a temperature where at least some of the reagents are liquid, for example, a temperature higher than 100° C. In general, higher reaction temperatures will result in increased rates of monomer conversion and polymerization while lower temperatures will decrease the amount of unsaturation in the polyol product. The preferred polymerization temperature range is from 60 to 160° C., preferably from 80 to 140° C., even more preferably from 100 to 140° C. Depending on the temperature and the volatility of the monomer(s) employed, the reaction pressure may be atmospheric, sub atmospheric, or above atmospheric.

It is known, for example from US2016369051 A1, that the reaction temperature may vary during the alkylene oxide metering phase within the above-described limits. In order to achieve an optimal balance between high alkylene oxide conversion and low by-product formation in the case of use of sensitive initiator compounds (for example sucrose), it is possible first to alkoxylate at low reaction temperatures (for example at 70 to 110° C.), and only when initiator conversion is sufficient, for example as soon as at least 50% by weight of the initiator compounds used have reacted with alkylene oxide at at least one active hydrogen atom, to move to higher reaction temperatures (for example to from 110 to 140° C.).

Post-reactions, as explained in this application, can likewise be performed at similar, or higher temperatures. Thus, in a particular embodiment of the method of the invention, there is a post-reaction step after the total amount of ligand and alkylene oxide reagents have been added, where the temperature is maintained for at least 15 min. Preferably, the temperature is maintained for at least 30 min, for at least 1 hour or for at least 2 hours.

In another particular embodiment of the method of the invention, there is a post-reaction step after the total amount of ligand and alkylene oxide reagents have been added, where the temperature is raised by at least 5° C., preferably by at least 10° C., for at least 15 min. Preferably, the temperature is raised for at least 30 min, for at least 1 hour or for at least 2 hours.

Advantageously, the amount of volatile organic compounds can be reduced by adjusting parameters such as temperature, or the vacuum pressure or duration.

In the method of the present invention, a ligand for chelating said alkali metal is added over a total period of time t≥5 min during the reaction time. The skilled person readily understands that, as is the case of all organic reactions, the reaction time depends mostly on the conditions of a particular reaction, such as the amounts of the reagents, the desired product, as well as temperature and pressure conditions.

In a particular embodiment, the reaction time is ≥10 min, ≥20 min, ≥30 min, ≥60 min, ≥75 min, ≥100 min, ≥150 min, ≥200 min, ≥300 min, or ≥400 min.

In another particular embodiment, the reaction time is ≤1000 min, ≤800 min, ≤700 min, ≤650 min, or ≤600 min.

In a preferred embodiment, the reaction time is comprised between 10 and 1000 min, between 10 and 800 min, between 20 and 800 min, between 30 and 800 min, between 60 and 800 min, between 60 and 700 min, between 60 and 600 min, most preferably between 100 and 600 min.

### Solvents

Although not essential, it may be advantageous to add an inert solvent to dissolve at least one of the reagents, such as the ligand, for example, or to reduce the viscosity of the reaction. The skilled person is well versed with this aspect and aromatic hydrocarbons such as toluene and ethers such as tetrahydrofuran are examples of suitable solvents. Bulk polymerization may be used when the polyol product is substantially liquid at the reaction temperature. It is preferred that the polyol reaction mixture be stirred and that the monomer(s) be added in a continuous manner to the mixture.

In a particular embodiment of the process of the invention, an inert solvent is used, preferably to dissolve the ligand. In a preferred embodiment of this particular embodiment, the ligand is added to the reaction as a solution.

### End-Capping Step and Work-Up

After polymerization of the alkylene oxide, alone or in combination with different alkylene oxides, the intermediate polymer can be reacted with ethylene oxide or a mono-substituted alkylene oxide such as propylene oxide, to yield an end-capped polyol.

In general, the reaction conditions employed during the end-capping step may be the same as those used to form the internal block. The amount of ethylene oxide or mono-substituted alkylene oxide (such as propylene oxide) to be added to produce the end-cap will vary depending upon the molecular weight and functionality of the intermediate polymer.

After the end-capping step, the crude polyol may be stripped to remove any remaining unreacted alkylene oxide and then treated to separate the alkali metal and ligand from the product. Any method known in the art for neutralizing a polyether polyol prepared using base catalysis is suitable, including water-washing and acid neutralization/precipitation.

Contacting the crude polyol with an adsorption agent such as magnesium silicate effectively reduces the alkali metal and ligand content of the product to acceptable levels, as described by Ionescu et al (see reference above), for example.

### Polyols

The polyols obtainable according to the process of the invention may be of any suitable molecular weight. Unless otherwise specified, polyols are to be understood as comprising both polyether polyols and polyester polyols.

Preferably, the polyols of the invention are polyether polyols.

For polyurethane applications, the number average molecular weight preferred will be from about 250 to 10,000. Most preferably, the molecular weight will range from about 400 to 10,000.

The polyols obtainable according to the process of this invention may be linear or branched.

Branching may be introduced by the use of an active hydrogen-containing initiator having a functionality greater than two or by the introduction of a multi-functional monomer such as a diepoxide during the polymerization to link growing polyol chains together. Polyols having an average functionality of two (diols) or three (triols) are most preferred, particularly for polyurethane applications.

In a particular embodiment, the polyol of the invention has a weight average molecular weight (Mw) value greater than 1500, preferably greater than 1800.

In another particular embodiment, the polyol of the invention has a polydispersity not greater than 1.09.

### Further Products

Because the polyols obtainable according to the process of this invention, preferably the polyether polyols, can have two or more terminal hydroxyl groups per polyol chain, the majority of which are primary and/or secondary, they may be used in various chain extension reactions to form useful high molecular weight polymer products. These polyols are suitable for use in any of the chain extension reactions in which conventional polyols are employed and which are well-known to those skilled in the art. The chain extension agent can be a polyfunctional compound containing electrophilic functional groups which react under appropriate conditions of temperature, pressure, and catalyst with the hydroxyl groups of the polyol. Such agents include di- or polyisocyanates, di- or polyanhydrides, and di- or polyepoxides. Useful polyester and polyamide block copolymers may also be formed with these polyols using any of the known condensation polymerization techniques.

Thus, the polyols obtainable according to the process of this invention, preferably the polyether polyols, may serve as intermediates in the preparation of a wide variety of thermoplastic resins, thermoset resins, elastomers, foams and the like. The polyols of this invention may also find utility as surfactants, dispersing agents, foam stabilizers, adhesives, and functional fluids.

Therefore, an aspect of the present invention is directed at the use of a polyol obtainable according to the process of the invention, in the synthesis of polyurethanes. The manufacture of polyurethanes is known in the art, for example by following the conditions disclosed in EP2256141, WO10020367A2, WO1001660, EP0010842, EP0035615 or EP0273099. This use can alternatively be drafted as a method for the synthesis of polyurethanes, comprising the method of the invention.

A further aspect is directed at a polyurethane polymer prepared by a reaction comprising contacting a polyisocyanate, preferably an organic polyisocyanate, with a polyol of the invention.

### FURTHER PARTICULAR EMBODIMENTS

Particular embodiment 1. Process for the alkali metal base-catalyzed preparation of polyols comprising oxyalkylene units, comprising the addition of a ligand for chelating said alkali metal over a total period of time t≥5 min during the reaction time.

Particular embodiment 2. The process according to particular embodiment 1, wherein a portion of said ligand is added at a moment in time corresponding to 5 to 100% of the reaction time.

Particular embodiment 3. The process according to any one of particular embodiments 1 or 2, wherein said ligand is added continuously, in pulses, or as a mixture of both over said total period of time.

Particular embodiment 4. The process according to any one of particular embodiments 1 to 3, wherein said ligand is added in pulses over said total period of time, preferably in pulses of continuous addition comprised between 1 second and 20 minutes.

Particular embodiment 5. The process according to any one of particular embodiments 1 to 4, wherein an alkali metal base catalyst, an active hydrogen-containing initiator molecule, and an alkylene oxide are provided to the reaction medium.

Particular embodiment 6. The process according to any one of particular embodiments 1 to 5, comprising the steps of:
a) contacting a fraction of the total amount of an alkylene oxide compound with an alkoxide, said alkoxide resulting from reacting an active hydrogen-containing initiator molecule and said alkali metal base catalyst;
b) adding to the reaction mixture resulting from step (a),
   i. a fraction of the total amount of said ligand; and/or
   ii. a fraction of the total amount of said alkylene oxide compound; and
c) repeating step (b) a plurality of times until the total amount of said alkylene oxide compound is added.

Particular embodiment 7. The process according to any one of particular embodiments 1 to 6, wherein said alkylene oxide compound is added continuously throughout the reaction, preferably at a constant rate.

Particular embodiment 8. The process according to any one particular embodiments 6 or 7, wherein step (a) comprises two steps:
(a1) providing a reaction mixture comprising an active hydrogen-containing initiator molecule and an alkali metal base catalyst, and submitting the product to a dehydration step to remove water; and
(a2) contacting a fraction of the total amount of an alkylene oxide compound with the alkoxide obtained in step (a1).

Particular embodiment 9. The process according to any one of particular embodiments 1 to 8, wherein said alkali metal base catalyst is selected from the group consisting of alkali metal hydrides, alkali metal carboxylates, alkali metal hydroxides, alkali metal alkoxides, alkali metal phenoxides, or mixtures thereof.

Particular embodiment 10. The process according to any one of particular embodiments 1 to 9, wherein said alkali metal base catalyst is an alkali metal hydroxide selected from K or Na.

Particular embodiment 11. The process according to any one of particular embodiments 1 to 10, wherein said initiator molecule is selected from the group consisting of water, C₂-C₃₀ diols, C₃-C₃₀ triols, ethylene diamine, mixture of isomers of toluene diamine, polyols containing at least 4 hydroxyl groups, sugar alcohols, monosaccharides, disaccharide and oligosaccharides.

Particular embodiment 12. The process according to any one of particular embodiments 1 to 11, wherein said alkylene oxide is selected from the group consisting of ethylene oxide, propylene oxide, oxetane, 1,2- and 2,3-butylene oxide, isobutylene oxide, epichlorohydrin, 1-pentene oxide, 2,3-pentene oxide, 2-methyl-1,2-butene oxide, 3-methyl-1,2-butene oxide, 1-hexene oxide, 2,3-hexene oxide, 3,4-hexene oxide, 2-methyl-1,2-pentene oxide, 4-methyl-1,2-pentene oxide, 2-ethyl-1,2-butene oxide, 1-heptene oxide, 1-octene oxide, 1-nonene oxide, 1-decene oxide, 1-undecene oxide, 1-dodecene oxide, 4-methyl-1,2-pentene oxide, butadiene monoxide, isoprene monoxide, cyclopentene oxide, cyclohexene oxide, cycloheptene oxide, cyclooctene oxide, styrene oxide, methylstyrene oxide, pinene oxide, and mixtures thereof. Particular embodiment 13. The process according to any one of particular embodiments 1 to 12, wherein said ligand is selected from the group consisting aprotic dipolar solvents, crown ethers, cryptates, polyamines, glymes, polyethylene glycols, ethoxylates of alcohols, diols, polyols, sulfoxides, aminoxides, phosphineoxides and phase transfer agents, preferably polyethylene glycols.

Particular embodiment 14. Polyol obtainable according to the process of any one of particular embodiments 1 to 13.

Particular embodiment 15. Use of a polyol according to particular embodiment 14, in the synthesis of polyurethanes.

The following non-limiting examples are intended to illustrate the present invention and should not be considered as limitations of the scope of the same.

### EXAMPLES

### Materials

The starter D-0411 is a diol molecule comprising propylene oxide moieties, characterized by a MW of 400 g/mol, by a hydroxyl number of 280 mg KOH/g and by a viscosity of 65 cP at 25° C. It is commercially available from @ REPSOL QUIMICA, S.A.

The starter R-1610 is a triol molecule comprising propylene oxide moieties, characterized by a MW of 1000 g/mol, by a hydroxyl number of 160 mg KOH/g and by a viscosity of 250 cP at 25° C. It is commercially available from @ REPSOL QUIMICA, S.A.

The starter R2510 is a triol molecule comprising propylene oxide moieties, characterized by a MW of 670 g/mol, by a hydroxyl number of 250 mg KOH/g and by a viscosity of 260 cP at 25° C. It is commercially available from @ REPSOL QUIMICA, S.A.

KOH, the ligands PEG1000 and PEG1500, and the ligand 18-crown-6 ether were obtained from Sigma-Aldrich. The propylene oxide was obtained from Fisher.

### Analytical Methods of Characterization

Gel permeation chromatography (GPC) was used to determine the number average molecular weight (Mn) and weight-average molecular weight (Mw). Polydispersity index was determined from Mw/Mn.

These values were determined against polystyrene standards by GPC using two PLGel Mixed D columns connected in series using a 1 ml/min THE flow without stabilizer, and a refraction index detector (RID) at 35° C. in an Agilent 1100 series HPLC. The solvent in the samples and the standards was THF without stabilizer. Different standards were used having different molecular weights.

Volatile compounds were analyzed in a HEAD-SPACE Gas Chromatography and FID detection apparatus with a 30 m. INNOWAX column. The quantification was determined against standards in a thoroughly stripped polyol as matrix. VOC's results were calculated with di-propylene glycol calibration curve.

The level of unsaturation (meq/g) was measured based in ASTM D4671 (measurement of unsaturation in polyether polyols). Unsaturated compounds present in the sample are reacted with mercuric acetate and methanol in a methanolic solution to produce acetoxy mercuric methoxy compounds and acetic acid. Sodium bromide is added to convert the mercuric acetate to the bromide. Acetic acid amount is then determined by a potentiometric determination with potassium hydroxide.

### Example 1 (Comparative). Synthesis of Comparative Polyols without Ligand

This example describes the synthesis of comparative polyether polyols wherein, contrary to the process of the invention, there is no ligand present. For each comparative sample (Reference samples 1, 2 and 3), the starter, the amounts of reagents and the reaction conditions are as indicated in the Table 1 below, except when indicated otherwise in the experimental procedure that follows.

The indicated amount of starter, and the indicated amount of a 50% KOH aqueous solution (half amount of pure KOH) were put in a stainless steel 1 L reactor. The reactor was purged with nitrogen and heated up to the indicated temperature. The reactor was then submitted to a vacuum for 1 hour to dehydrate the medium.

The indicated amount of propylene oxide was then added at the indicated constant rate of addition, and the pressure was kept under observation to ensure it did not surpass 3.5 bar.

Once the addition of the alkylene oxide was finished, the reaction was maintained during the indicated post-reaction time and then it was submitted to a vacuum for 30 min to remove residual monomers, while maintaining said indicated temperature.

The reaction was then cooled down to 60° C. and the product was recovered.

TABLE 1
Amounts, reagents and experimental conditions leading to the
synthesis of comparative reference samples Ref. 1, 2 and 3.

| Sample | Ref. 1 | Ref. 2 | Ref. 3 |
|---|---|---|---|
| Starter | 100 g of | 166.5 g of | 66 g |
| | Diol D-0411 | Triol R-1610 | triol R2510 |
| Aqueous KOH | 3 g of 50% | 2.2 g of 50% | 2.5 g of 50% |
| | KOH solution | KOH solution | KOH solution |
| Propylene Oxide (PO) | 400 g | 333.5 g | 534 g |
| Rate of PO addition | 1 g/min | 1.2 g/min | 0.9 g/min |
| Temperature | 115° C. | 130° C. | 115° C. |
| Post reaction time | 3 hours | 2 hours | 3 hours |

### Example 2 (Comparative). Synthesis of Comparative Polyols with the Addition of Ligands at a Single Moment in Time

This example describes the synthesis of comparative polyether polyols wherein, contrary to the process of the invention, the totality of the ligand was added at a single moment in time, instead of over a total period of time t≥5 min during the reaction time.

The synthesis steps were the same as those for obtaining the indicated reference samples (see example 1), with the exception that the amounts of the ligands indicated in Table 2 were also added to the reactor at the same time as the starter and KOH reactants, prior to the addition of the alkylene oxide.

TABLE 2
Ligands and amounts added in the synthesis of comparative
samples C1-C5.

| Sample | C1 | C2 | C3 | C4 | C5 |
|---|---|---|---|---|---|
| Procedure | Ref. 1 | Ref. 1 | Ref. 2 | Ref. 2 | Ref. 3 |
| Ligand | PEG | PEG | 18- | F3231 | PEG |
| | 1000 | 1500 | crown-6 | | 1500 |
| Amount | 6.7 g | 10 g | 0.52 g | 25.78 g | 10 g |
| Ligand:KOH | 1:4 | 1:4 | 1:10 | 1:4 | 1:4 |
| molar ratio | | | | | |

### Example 3. Synthesis of a Polyol with PEG 1000 Added as a Plurality of Pulses (S1)

This example describes the synthesis of a polyether polyol according to the process of the invention, wherein sub-stoichiometric amounts of the ligand (PEG 1000) were added as a plurality of pulses, i.e., a method with addition of the ligand over a total period of time t≥5 min, wherein at least a portion of the ligand was added during 5 to 80% of the reaction time. 100 g of the diol starter D-0411, and 3 g of a 50% KOH aqueous solution (1.5 g of pure KOH) were put in a stainless steel 1 L reactor. The reactor was purged with nitrogen and heated up to a temperature of 115° C. The reactor was then submitted to a vacuum for 1 hour to dehydrate the medium.

6.7 g of the ligand PEG 1000 were added in 16 regular pulses, where each pulse consisted of a 12-minute period of addition of propylene oxide at a constant rate of 1 g/min, followed by a 3-minute period of addition of a mixture of propylene oxide and PEG 1000 at a constant rate of 1 g/min. Once the 16 pulses ended (at t=4 hours, and the 6.7 g of the ligand were added, corresponding to a PEG:KOH molar ratio of 1:4), the addition of propylene oxide was maintained at a constant rate of 1 g/min until a total amount of 400 g of propylene oxide was added. The pressure was kept under surveillance to ensure it did not surpass 3.5 bar.

Once the addition of the alkylene oxide was finished, the reaction was kept for 3 hours and then it was submitted to a vacuum for 30 min to remove residual monomers, while maintaining the temperature at 115° C.

The reaction was then cooled down to 60° C. and the product (S1) was recovered.

### Example 4. Synthesis of a Polyol with PEG 1500 Added as a Plurality of Pulses (S2)

For this example, the synthesis of Example 3 was reproduced, with the exception that 10 g of PEG1500 were used (corresponding to a PEG:KOH molar ratio of 1:4), instead of the 6.7 g of PEG1000.

### Example 5. Synthesis of a Polyol with 18-Crown-6 Added as a Plurality of Pulses (S3)

This example describes the synthesis of a polyether polyol according to the process of the invention, wherein sub-stoichiometric amounts of the ligand (18-crown-6) were added as a plurality of pulses, i.e., a method with addition of the ligand over a total period of time t≥5 min, wherein at least a portion of the ligand was added during 5 to 90% of the reaction time.

166.5 g of the triol starter R-1610, and 2.2 g of a 50% KOH solution (1.1 g of pure KOH) were put in a stainless steel 1 L reactor. The reactor was purged with nitrogen and heated up to a temperature of 130° C. The reactor was then submitted to a vacuum for 1 hour to dehydrate the medium.

0.52 g of the ligand 18-crown-6 were added in 17 regular pulses, where each pulse consisted of a 12-minute period of addition of propylene oxide at a constant rate of 1.2 g/min, followed by a 3-minute period of addition of propylene oxide and 18-crown-6 at a constant rate of 1.2 g/min. Once the 17 pulses ended (and the 0.52 g of the ligand were added, corresponding to a 18-crown-6:KOH molar ratio of 1:10), the addition of propylene oxide was maintained at a constant rate of 1.2 g/min until a total amount of 333.5 g of propylene oxide was added. The pressure was kept under surveillance to ensure it did not surpass 3.5 bar. Once the addition of the alkylene oxide was finished, the reaction was kept for 2 hours and then it was submitted to a vacuum for 30 min to remove residual monomers, while maintaining the temperature at 130° C.

The reaction was then cooled down to 60° C. and the product was recovered.

### Example 6. Synthesis of a Polyol with Polyol F3231 Added as a Plurality of Pulses (S4)

For this example, the synthesis of Example 5 was reproduced, with the exception that 25.78 g of polyol F3231 were used as ligand (corresponding to a polyol F3231:KOH molar ratio of 1:4), instead of the 0.52 g of 18-crown-6.

### Example 7. Synthesis of a Polyol with PEG1500 Added as a Plurality of Pulses (S5)

This example describes the synthesis of a polyether polyol according to the process of the invention, wherein sub-stoichiometric amounts of the ligand (PEG1500) were added as a plurality of pulses, i.e., a method with addition of the ligand over a total period of time t≥5 min, wherein at least a portion of the ligand was added during 5 to 99% of the reaction time.

66 g of the triol starter (R2510), and 2.52 g of a 50% KOH solution (1.26 g of pure KOH) were put in a stainless steel 1 L reactor. The reactor was purged with nitrogen and heated up to a temperature of 115° C. The reactor was then submitted to a vacuum for 1 hour to dehydrate the medium.

10 g of the ligand PEG 1500 were added in 40 regular pulses, where each pulse consisted of a 12-minute period of addition of propylene oxide at a constant rate of 0.9 g/min, followed by a 3-minute period of addition of propylene oxide and PEG 1500 at a constant rate of 0.9 g/min. Once the 40 pulses ended (and the 10 g of the ligand were added, corresponding to a PEG1500:KOH molar ratio of 1:4), the addition of propylene oxide was maintained at a constant rate of 0.9 g/min until a total amount of 534 g of propylene oxide was added. The pressure was kept under supervision to ensure it did not surpass 3.5 bar. Once the addition of the alkylene oxide was finished, the reaction was kept for 3 hours and then it was submitted to a vacuum for 30 min to remove residual monomers, while maintaining the temperature at 115° C.

The reaction was then cooled down to 60° C. and the product was recovered.

Results. Characterization of the Polyether Polyols

Table 3 summarizes the GPC, VOCs and unsaturation values of the samples that were prepared using the diol starter D-0411. It can be seen that when the polyols are prepared according to the process of the invention, there is a reduction in the unsaturation of up to about 46% with respect to comparative reference 1 (no ligand), and from 35% to 39% with respect to the comparative samples C1 and C2 (% of reduction not shown).

TABLE 3
Gel phase chromatography, Volatile Organic Compounds,
Unsaturation and reduction in unsaturation of
the polyol comparative samples Ref. 1, C1 and C2, against
samples S1 and S2, prepared according to the examples above.

| | GPC | | | VOCs | Unsaturation | Reduction in |
|---|---|---|---|---|---|---|
| Sample | Mn | Mw | PD | (ppm) | (meq/g) | unsaturation |
| Ref. 1 | 2063 | 2259 | 1.10 | 9199 | 0.030 | — |
| (no ligand) | | | | | | |
| C1 | 1911 | 2101 | 1.10 | 12916 | 0.026 | 11.9% |
| (PEG1000) | | | | | | |
| C2 | 1935 | 2121 | 1.10 | 6299 | 0.026 | 11.9% |
| (PEG1500) | | | | | | |
| S1 | 1927 | 2084 | 1.08 | 8157 | 0.016 | 45.8% |
| (pulse addition | | | | | | |
| of PEG1000) | | | | | | |
| S2 | 1763 | 1884 | 1.07 | 5704 | 0.017 | 42.4% |
| (pulse addition | | | | | | |
| of PEG1500) | | | | | | |

Table 4 summarizes the GPC, VOCs and unsaturation values of the samples that were prepared using the triol starter R-1610. It can be seen that when the polyols are prepared according to the process of the invention, there is a reduction in the unsaturation of up to about 62% with respect to both comparative reference 2 (no ligand) and also with respect to the comparative sample C4 (% of reduction not shown).

TABLE 4
Gel phase chromatography, Volatile Organic Compounds,
Unsaturation and reduction in unsaturation of the
polyol comparative samples Ref. 2, C3 and C4, against
samples S3 and S4, prepared according to the examples above.

| | | | | | | Reduction |
|---|---|---|---|---|---|---|
| | GPC | | | VOCs | Unsaturation | in un- |
| Sample | Mn | Mw | PD | (ppm) | (meq/g) | saturation |
| Ref. 2 | 3995 | 4258 | 1.07 | 3558 | 0.037 | — |
| (no ligand) | | | | | | |
| C3 | 3906 | 4155 | 1.06 | 1130 | 0.032 | 14.3% |
| (18-crown-6) | | | | | | |
| C4 | 3840 | 4304 | 1.12 | 2349 | 0.037 | 0% |
| (polyol F3231) | | | | | | |
| S3 | 3558 | 3890 | 1.09 | 1686 | 0.014 | 61.9% |
| (pulse addition | | | | | | |
| of 18-crown-6) | | | | | | |
| S4 | 3397 | 3706 | 1.09 | 2564 | 0.017 | 53.5% |
| (pulse addition | | | | | | |
| of polyol | | | | | | |
| F3231) | | | | | | |

Table 5 summarizes the GPC, VOCs and unsaturation values for the average of the samples that were prepared using the Triol starter (R2510). It can be seen that when the polyols are prepared according to the process of the invention, there is a reduction in the unsaturation of up to about 10% with respect to both comparative reference 3 (no ligand) and also with respect to the comparative sample C5 (% of reduction not shown).

TABLE 5
Gel phase chromatography, Volatile Organic Compounds, Unsaturation
and reduction in unsaturation of the polyol comparative samples Ref. 3,
C5 and C7, against sample S5, prepared according to the examples above.

| | | | | | Un- | Reduction in |
|---|---|---|---|---|---|---|
| | GPC | | | VOCs | saturation | unsaturation |
| Sample | Mn | Mw | PD | (ppm) | (meq/g) | (%) |
| Ref. 3 | 5407 | 5852 | 1.08 | 25320 | 0.072 | — |
| (no ligand) | | | | | | |
| C5 | 5478 | 5867 | 1.07 | 9923 | 0.075 | 0.0% |
| (PEG 1500) | | | | | | |
| S5 | 4947 | 5495 | 1.11 | 10780 | 0.065 | 9.7% |
| (pulse addition | | | | | | |
| of PEG1500) | | | | | | |

### Example 8. Synthesis of a Polyol with the Increased Rate of Addition of Alkylene Oxide

As mentioned in the description above, and as shown in the results above, the process of the invention leads to polyol products with a lower level of unsaturations when compared to polyol products obtained by a similar process except that no ligand is added over a total period of time t≥5 min during the reaction time. Furthermore, the process of the invention leads to a reduction in the maximum operating pressure. This means that as long as the product specifications are met (for example, unsaturation level below specification), the process of the invention allows an increase in the production capacity, for example, by increasing the addition rate of the alkylene oxide, or by raising the temperature, and thus reducing the reaction time.

This example thus describes the further advantage of the process of the invention, which is the ability to increase the addition rate of the alkylene oxide and thus reducing the reaction time, leading to a polyol product which exhibits the same properties as one obtained without the addition of a ligand, and thus at the expense of a longer time.

The synthesis steps were the same as those conducted for obtaining sample S5 (in Example 7, with the exception that the addition rate was increased by 50%, to 1.5 g/min.

The resulting polyol had similar properties to the reference polyol Ref. 3 and was characterized by Mn, Mw and PD values of 5013, 5542 and 1.11, respectively, and unsaturation level of 0.071 meq/g and Total VOCs of 22476 ppm.

1. Process for the alkali metal base-catalyzed preparation of polyols comprising oxyalkylene units, comprising the addition of a ligand for chelating said alkali metal over a total period of time t≥5 min during the reaction time, wherein a portion of said ligand is added at a moment in time corresponding to 5 to 100% of the reaction time.

2. The process according to claim 1, wherein at least a portion of the ligand is added not before 5 min since the start of the reaction.

3. The process according to claim 1, wherein said ligand is added continuously, in pulses, or as a mixture of both over said total period of time.

4. The process according to claim 1, wherein said ligand is added in pulses over said total period of time, preferably in pulses of continuous addition comprised between 1 second and 20 minutes.

5. The process according to claim 1, wherein an alkali metal base catalyst, an active hydrogen-containing initiator molecule, and an alkylene oxide are provided to the reaction medium.

6. The process according to claim 1, comprising the steps of:
a) contacting a fraction of the total amount of an alkylene oxide compound with an alkoxide, said alkoxide resulting from reacting an active hydrogen-containing initiator molecule and said alkali metal base catalyst;
b) adding to the reaction mixture resulting from step (a),
i. a fraction of the total amount of said ligand; and/or
ii. a fraction of the total amount of said alkylene oxide compound; and
c) repeating step (b) a plurality of times until the total amount of said alkylene oxide compound is added.

7. The process according to claim 1, wherein said alkylene oxide compound is added continuously throughout the reaction, preferably at a constant rate.

8. The process according to claim 6, wherein step (a) comprises two steps:
(a1) providing a reaction mixture comprising an active hydrogen-containing initiator molecule and an alkali metal base catalyst, and submitting the product to a dehydration step to remove water; and
(a2) contacting a fraction of the total amount of an alkylene oxide compound with the alkoxide obtained in step (a1).

9. The process according to claim 1, wherein said alkali metal base catalyst is selected from the group consisting of alkali metal hydrides, alkali metal carboxylates, alkali metal hydroxides, alkali metal alkoxides, alkali metal phenoxides, or mixtures thereof.

10. The process according to claim 1, wherein said alkali metal base catalyst is an alkali metal hydroxide selected from K or Na.

11. The process according to claim 1, wherein said initiator molecule is selected from the group consisting of water, C₂-C₃₀ diols, C₃-C₃₀ triols, ethylene diamine, mixture of isomers of toluene diamine, polyols containing at least 4 hydroxyl groups, sugar alcohols, monosaccharides, disaccharide and oligosaccharides.

12. The process according to claim 1, wherein said alkylene oxide is selected from the group consisting of ethylene oxide, propylene oxide, oxetane, 1,2- and 2,3-butylene oxide, isobutylene oxide, epichlorohydrin, 1-pentene oxide, 2,3-pentene oxide, 2-methyl-1,2-butene oxide, 3-methyl-1,2-butene oxide, 1-hexene oxide, 2,3-hexene oxide, 3,4-hexene oxide, 2-methyl-1,2-pentene oxide, 4-methyl-1,2-pentene oxide, 2-ethyl-1,2-butene oxide, 1-heptene oxide, 1-octene oxide, 1-nonene oxide, 1-decene oxide, 1-undecene oxide, 1-dodecene oxide, 4-methyl-1,2-pentene oxide, butadiene monoxide, isoprene monoxide, cyclopentene oxide, cyclohexene oxide, cycloheptene oxide, cyclooctene oxide, styrene oxide, methylstyrene oxide, pinene oxide, and mixtures thereof.

13. The process according to claim 1, wherein said ligand is selected from the group consisting aprotic dipolar solvents, crown ethers, cryptates, polyamines, glymes, polyethylene glycols, ethoxylates of alcohols, diols, polyols, sulfoxides, aminoxides, phosphineoxides and phase transfer agents, preferably polyethylene glycols.

14. Polyol obtainable according to the process of claim 1.

15. Method for the synthesis of polyurethanes comprising a polyol according to claim 14.

16. The process according to claim 4, wherein said pulses are pulses of continuous addition comprised between 1 second and 20 minutes.

17. The process according to claim 7, wherein said alkylene oxide compound is added continuously throughout the reaction at a constant rate.

18. The process according to claim 13, wherein said ligand is selected from the group consisting of polyethylene glycols.
